(19) United States
(12) Patent Application Publication
(10) Pub. No.: US 2010/0020005 A1
(43) Pub. Date: Jan. 28, 2010

(54) APPARATUS AND METHOD FOR COMPENSATING BRIGHTNESS OF BACKLIGHT

(76) Inventors: Hye Dong Jung, Seoul (KR); Ki Man Jeon, Gyeonggi-do (KR); Hyung Su Lee, Gyeonggi-do (KR)

Correspondence Address: North Star Intellectual Property Law, PC, P.O. Box 34688, Washington DC, DC, 20043, US

(21) Appl. No.: 12/179,670

(22) Filed: Jul. 25, 2008

(30) Foreign Application Priority Data
Jul. 24, 2008 (KR) 10-2008-72383

(51) Int. Cl. G09G 3/36

(52) U.S. Cl. 345/102

(57) ABSTRACT

Provided are a display device and method. The display device includes an image analyzing unit for analyzing an input image signal to extract block-based brightness information of a divided display region, a block control value calculating unit for calculating a backlight control value for a backlight block corresponding to the block of the display region by using the brightness information, and a block control value compensating unit for determining whether to perform a scaling process of reducing brightness degree at a predetermined ratio according to brightness of the respective backlight blocks considering brightness degree of adjacent blocks, and outputting a backlight compensation control value.

### CROSS-REFERENCE TO RELATED APPLICATIONS

This application claims benefit under 35 U.S.C. §119(a) of a Korean Patent Application No. 10-2008-72383, filed on Jul. 24, 2008, the disclosure of which is incorporated herein by reference in its entirety.

### TECHNICAL FIELD

The following description relates to a display device and method, and more particularly, to a display device and method which are capable of compensating degradation of an image quality in a backlight local dimming control for reducing power consumption.

### BACKGROUND

Generally, a liquid crystal display (LCD) manufactured by a thin film transistor (TFT) technology is a liquid crystal screen that is widely used in an apparatus having a display such as a notebook computer or a laptop computer. Each pixel of the LCD may have one transistor. Typically, each pixel having one transistor means that a small amount of current is consumed in making the pixel emit light, and the pixel may be quickly turned on and off.

A backlight of a conventional TFT LCD has employed a method for controlling an overall brightness in order to reduce power consumption. Such a method may achieve the reduction of the power consumption by dimming the overall brightness, but dimming the brightness of the overall screen may cause degradation of image quality as a whole.

To solve problems related to a technology for controlling the overall brightness of a backlight, there has been proposed a brightness control method that divides the backlight in a one-dimensional manner by controlling cold cathode fluorescent lamps (CCFLs).

While such a method may improve upon the method for controlling the overall brightness of the overall backlight, only a one-dimensional control may be possible and a control of a fine region may be impossible due to a physical limitation of the CCFL.

In a backlight of a TFT LCD, CCFLs are being gradually replaced with LEDs and thus a two-dimensional region division and control of the backlight may be possible. Such a two-dimensional division and control of the backlight may be referred to as a backlight local dimming (or division dimming) control.

A backlight local dimming control performs a brightness control by dividing a backlight into two-dimensional M×N blocks, dividing a brightness signal of an input image so that it coincides with the backlight blocks, and extracting the brightness signal within the divided regions.

However, where a backlight is controlled using such a control method, while, for example, a TFT LCD may exhibit improved performance in view of the reduction of the power consumption and contrast improvement of an image, a blocking phenomenon may occur in an image backside of a boundary of a divided backlight blocks. That is, a contour of the backlight may appear due to brightness difference between sections. Such a backlight blocking phenomenon may result where the backlight is controlled according to an input image.

### SUMMARY

Accordingly, according to an aspect, there is provided a display device and method capable of compensating degradation of an image quality in a backlight local dimming control for reducing power consumption.

According to another aspect, there is provided a display device and method capable of compensating for a backlight blocking phenomenon occurring in a boundary of divided backlight blocks in a backlight local dimming control.

According to still another aspect, there is provided a signal processing apparatus comprising an image analyzing unit for analyzing an input image signal to extract block-based brightness information of a divided display region, a block control value calculating unit for calculating a backlight control value for a backlight block corresponding to the block of the display region by using the brightness information, and a block control value compensating unit for determining whether to perform a scaling process of reducing brightness degree at a predetermined ratio according to brightness of the respective backlight blocks considering brightness degree of adjacent blocks, and outputting a backlight compensation control value.

According to still another aspect, there is provided a display device comprising a liquid crystal display panel, divided into a plurality of display regions, for displaying an image according to an input image signal, a backlight unit, divided into a plurality of backlight blocks corresponding to divided positions of the display region, for back-light the liquid crystal display panel, a signal processing unit for determining whether to perform a scaling process of reducing brightness degree at a predetermined ratio according to brightness of the respective backlight blocks considering brightness degree influenced by adjacent blocks in the respective backlight blocks by using brightness information of the input image signal, and outputting a backlight compensation control value, and a backlight controlling unit for controlling the backlight unit of the backlight block according to the backlight compensation control value.

According to still another aspect, there is provided a display device comprising an image analyzing unit for analyzing the input image signal to extract block-based brightness information of a divided display region, a block control value calculating unit for calculating initial brightness information of respective backlight blocks corresponding to blocks of the display region by using the brightness information, and a block control value compensating unit for converting the initial brightness information into middle brightness information, considering brightness degree influenced by brightness degree of adjacent blocks in the respective backlight blocks, and outputting a backlight control signal corresponding to a final brightness information obtained by scaling the middle brightness information at a predetermined ratio.

According to still another aspect, there is provided a display method for displaying an image corresponding to an input image signal by back-lighting, comprising determining whether to perform a scaling process of reducing brightness degree at a predetermined ratio according to brightness of the respective backlight blocks considering brightness degree according to the input image signal, and generating a backlight compensation control value, and controlling backlight units corresponding to the backlight block to back-light a liquid crystal display panel according to the backlight compensation control value.

Other features will become apparent to those skilled in the art from the following detailed description, which, taken in conjunction with the attached drawings, discloses exemplary embodiments of the invention.

### BRIEF DESCRIPTION OF THE DRAWINGS

FIG. 1 is an exemplary diagram illustrating a measurement result where a brightness is measured in a transverse direction in a state that one block of divided backlight blocks is turned on with a maximum brightness.

FIGS. 2A through 2D are diagrams for explaining a filtering process according to an exemplary embodiment.

FIG. 3 is an exploded perspective view for explaining an LCD that is operated by a backlight brightness compensating apparatus according to an exemplary embodiment.

FIG. 4 is a block diagram of a display device according to an exemplary embodiment.

FIG. 5 is a diagram for explaining an exemplary operation of a block control value compensating unit of FIG. 4.

FIG. 6 is a flowchart illustrating a display method according to an exemplary embodiment.

Throughout the drawings and the detailed description, unless otherwise described, the same drawing reference numerals will be understood to refer to the same elements, features, and structures.

### DETAILED DESCRIPTION

The following detailed description is provided to assist the reader in gaining a comprehensive understanding of the methods, apparatuses and/or systems described herein. Accordingly, various changes, modifications, and equivalents of the systems, apparatuses and/or methods described herein will be suggested to those of ordinary skill in the art. Also, descriptions of well-known functions and constructions are omitted to increase clarity and conciseness.

According to an aspect, an apparatus and method for compensating a brightness of a backlight, proposes a structure which is capable of compensating a backlight blocking phenomenon so as to suppress a backlight blocking phenomenon from occurring in a local dimming control.

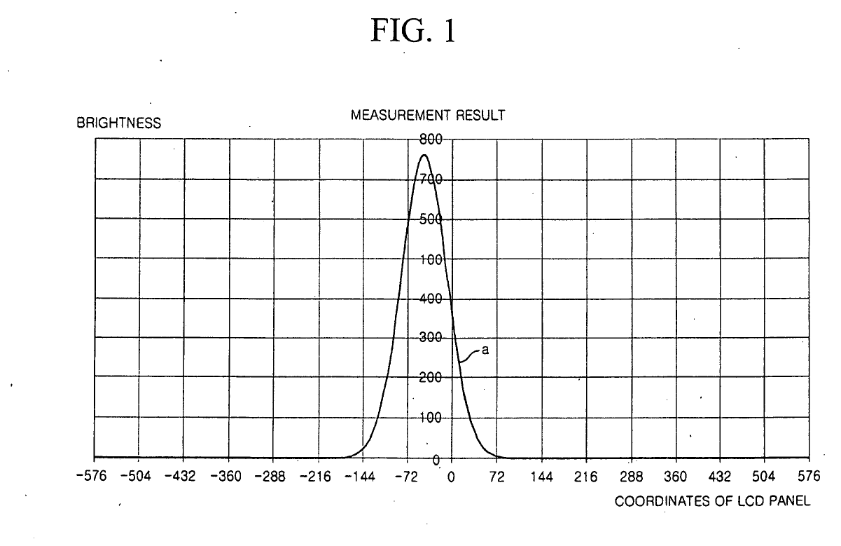

FIG. 1 illustrates a measurement result where a brightness is measured in a transverse direction in a state that one block of divided backlight blocks is turned on with a maximum brightness. In FIG. 1, a horizontal axis represents coordinates of a liquid crystal panel, and a vertical axis represents brightness.

As illustrated in FIG. 1, light scattering at one block is generated in the same shape in all directions around a block corresponding to a light source. Thus, only the result measured in one plane direction is employed.

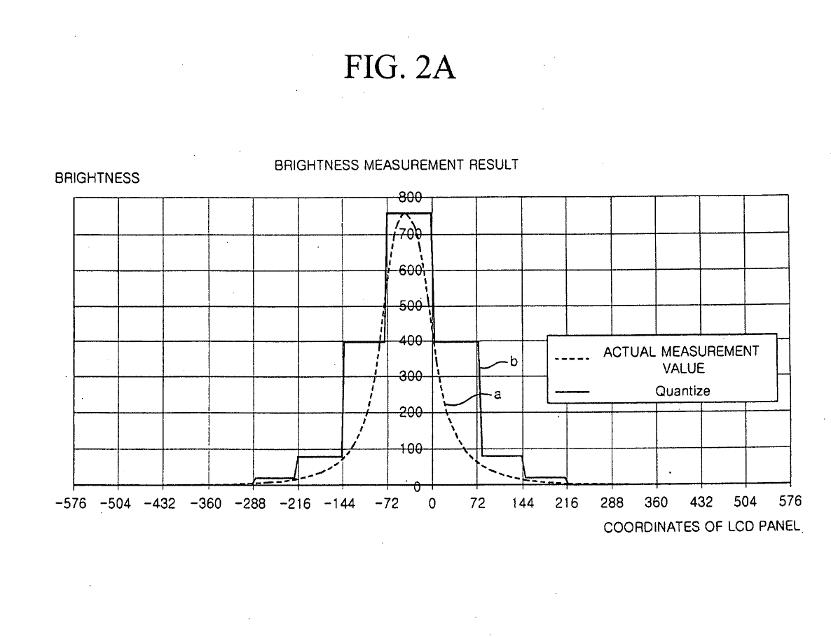

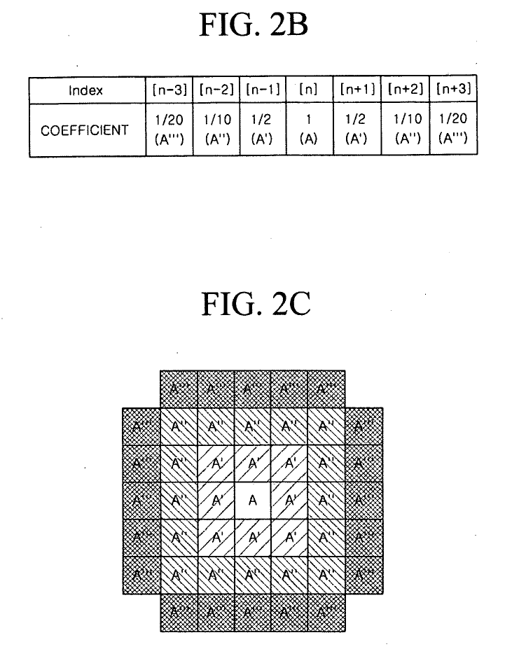

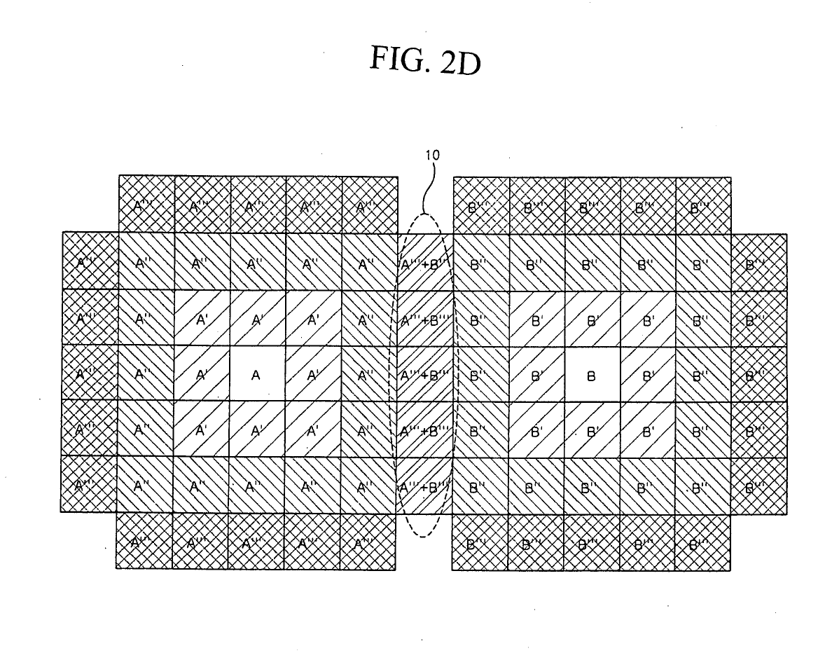

It may be seen that light generated from one block \textcircled{a} is scattered up to predetermined left and right regions. Using this result, degree of influence on adjacent blocks may be simply shown as in FIG. 2A.

In FIG. 2A, a reference symbol \textcircled{b} represents a representative value of degree of light received by an adjacent backlight block. This is generalized and summarized as a ratio shown in FIG. 2B. In FIG. 2B, [n] represents a turned-on backlight block, and [n−1] and [n+1] represent adjacent blocks that exist on the left and right sides of the [n] block. [n−2] and [n+2] represent blocks that are spaced far from [n−1] and [n+1] with respect to the [n] block and adjacent to [n−1] and [n+1], and [n−3] and [n+3] represent blocks that are spaced far from [n−2] and [n+2] with respect to the [n].

Where a coefficient of the [n] block is “1”, the [n−1] and [n+1] blocks may have a brightness coefficient of “½”, the [n−2] and [n+2] blocks may have a brightness coefficient of 1/10, and the [n−3] and [n+3] blocks may have a brightness coefficient of 1/20.

A relative definition of the adjacent blocks may be different according to the division methods of the targets and regions. The brightness coefficient of the region \textcircled{b} may be applied in various types, such as maximum or minimum, middle, and average of brightness that the has an influence on the corresponding adjacent blocks by the region determination, and this may be determined according to kind and arrangement of the light source. In the exemplary embodiment of FIG. 2A, the brightness coefficients are determined based on the maximum value of the brightness having an influence on the adjacent blocks.

As illustrated in FIG. 2C, spatial filters may be configured with respect to brightness control signals in each block, based on the brightness ratio according to the positions of the adjacent blocks defined in FIG. 2B.

A filtering process, that is, a process of filtering brightness in each block considering brightness of adjacent blocks according to an exemplary embodiment will be described below with reference to FIGS. 2C and 2D.

Using a filter of FIG. 2C, influence of brightness due to two blocks A and B, where the light source is placed, may be easily calculated. That is, in the embodiment of FIG. 2D, a backlight control value in each backlight block is calculated with reference to FIG. 2B, and a backlight control value is recalculated considering brightness degree influenced by a backlight control value of an adjacent block in each backlight block.

That is, based on a brightness ratio according to the position of the adjacent block in each backlight block, light overlapping regions are formed. By filtering brightness with respect to the light overlapping regions (A′″+B′″) 10, the influence of brightness due to the adjacent blocks may be easily checked.

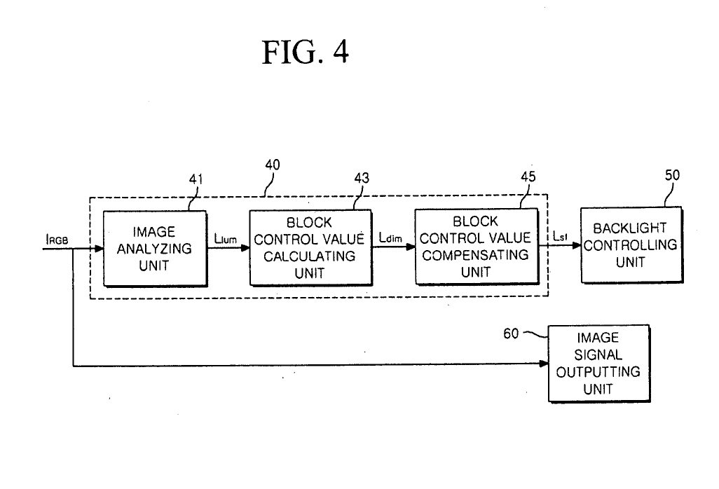

Next, the blocking phenomenon is suppressed by compensating the brightness in each block, considering the influence of the adjacent blocks. This will be described later with reference to FIGS. 4 through 6.

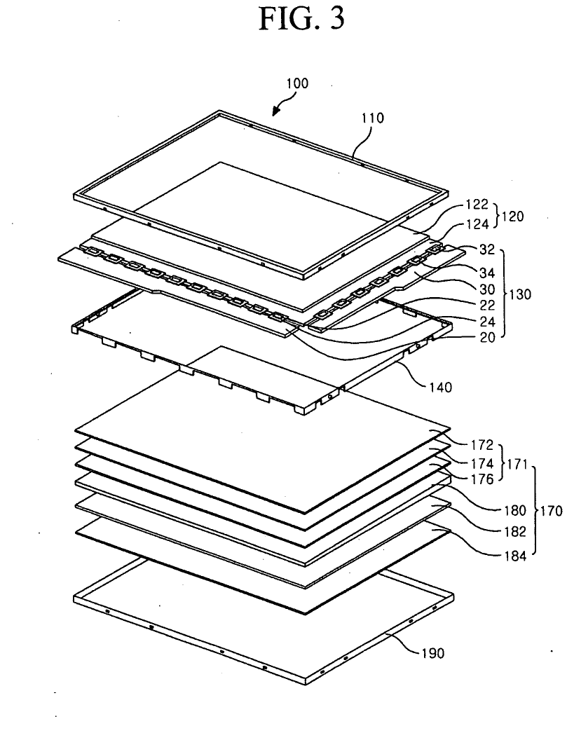

Meanwhile, FIG. 3 illustrates an LCD that is operated by a backlight brightness compensating apparatus according to an exemplary embodiment. Although the backlight brightness compensating apparatus is described using a direct type LCD in FIG. 3, it is only exemplary and it is apparent that the backlight brightness may also be compensated through, for example, an edge-type LCD.

Referring to FIG. 3, the LCD 100 comprises an LCD panel 120 for displaying an image according to an image signal, a backlight assembly 170 for providing light to the LCD panel 120, a bottom chassis 190 for receiving the LCD panel 120 and the backlight assembly 170, a mold frame 140, a top chassis 110, and a driving circuit 130 for driving the LCD panel 120.

The LCD panel 120 comprises a TFT substrate 124, and a color filter substrate 122 disposed to face the TFT substrate 124. Liquid crystal (not shown) is injected between the TFT substrate 124 and the color filter substrate 122. TFTs acting as a switching element are formed in a matrix form. Using the TFTs, light transmittance of the liquid crystal is controlled to display an image. The LCD panel 120 is divided in M×N regions. The TFT has a gate electrode (not shown) connected to a gate line (not shown), a source electrode (not shown) connected to a data line (not shown), and a drain electrode (not shown) connected to a pixel electrode (not shown). RGB filters for displaying an image are formed in the color filter substrate 122. Therefore, light transmitted through the liquid crystal is reproduced as predetermined colors through the RGB filters, thereby reproducing the image.

The backlight assembly 170 comprises an LED package 182, a reflection sheet for preventing external emission of light generated from the LED package 182, a light guide panel 180 for guiding incident light generated from the LED package 182, and an optical sheet 171 disposed on the light guide panel 180 to improve diffusion and brightness of light supplied from the light guide panel 180. The optical sheet 171 comprises a diffusion sheet 176 for diffusing light guided by the light guide panel 180, a prism sheet 174 for condensing the diffused light, and a protection sheet 172 for protecting the surface of the prism sheet 174. The optical sheet 171 supplies light to the LCD panel 120.

The LED package 182 comprises a plurality of LEDs (not shown) corresponding to two-dimensional blocks divided into M×N regions. The plurality of LEDs are back-lighted by the backlight control signal that compensates the backlight blocking phenomenon from a backlight controller which will be described later.

The bottom chassis 190 has a rectangular frame shape and has a space where the backlight assembly 170 is received inside and supported at a lower portion.

The mold frame 140 is made of synthetic resin or plastic and may be advantageous to insulate the driving circuit 130. The mold frame 140 receives the LCD panel 120 and the backlight assembly 170 to prevent their movement, and absorbs external impact applied to the LCD panel 120 and the backlight assembly 170.

The top chassis 110 covers edges of the top surface of the LCD panel 120 and the top/bottom/left/right sides of the top chassis 110 are configured to cover the sides of the mold frame 140 and the bottom chassis 190.

The driving circuit 130 comprises a gate driver 34, a data driver 24, a timing controller (not shown), and various circuit elements. The driving circuit 130 is mounted on a gate printed circuit board (PCB) 30 and a data PCB 20, and generates various signals necessary to reproduce the image.

FIG. 4 illustrates a display device according to an exemplary embodiment.

Referring to FIG. 4, the display device 200 according to an exemplary embodiment comprises a signal processing unit 40, a backlight controlling unit 50, and an image signal outputting unit 60. The display device 200 may further include a memory (not shown).

The signal processing unit 40 calculates brightness of each backlight block using brightness information extracted by analyzing an input image signal, considering brightness degree influenced by adjacent blocks in each backlight block. The signal processing unit 40 determines whether to perform a scaling for reducing the brightness degree to a predetermined ratio according to the calculated brightness of each backlight block, and performs the scaling. In this case, the signal processing unit 40 may include an image analyzing unit 41, a block control value calculating unit 43, and a block control value compensating unit 45.

The image analyzing unit 41 analyzes the input image signal and extracts brightness information (Lₗᵤₘ) in each block of the divided display region.

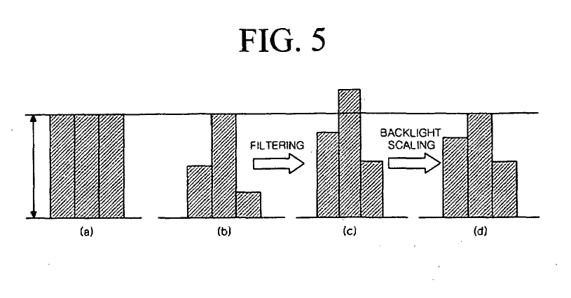

The block control value calculating unit 43 calculates a backlight control value (L_{dim}) for each backlight block corresponding to the block of the display region by using the brightness information (Lₗᵤₘ).

Where the brightness of each backlight block considering the brightness degree of the adjacent blocks exceeds a preset threshold brightness (see FIG. 5C), the block control value compensating unit 45 outputs a backlight compensation control value corresponding to the scaled brightness of the backlight block (see FIG. 5D) in order to make the brightness of the backlight block be less than the preset threshold brightness.

That is, the block control value compensating unit 45 performs the scaling so that the brightness of the brightest backlight block among the backlight blocks considering the brightness degree of the adjacent blocks is made to be less than the preset threshold brightness, and it outputs a backlight compensation control value (L_{sf}) corresponding to the scaled brightness of the backlight block. The threshold brightness may be set by a user, or may be a value that is automatically determined according to an image mode (for example, a movie mode, a documentary mode, a drama mode, etc.), or a value that is accordingly determined considering brightness of surroundings, or a value that is determined by a manufacturer, considering kind and arrangement of the light source in a manufacturing step. In addition, the block control value compensating unit 45 scales the brightness degree of other blocks, based on a predetermined ratio given by changing the highest brightness.

Therefore, the block control value compensating unit 45 outputs the backlight compensation control value (L_{sf}) corresponding to the scaled brightness of each backlight block.

The scaling process may be performed by a typical normalization process. Where the control value and the brightness of the light source within the block are linear, the ratio of the maximum filtered brightness of the block to the threshold brightness is set as a scaling factor, and the control value for the light source of each block is reduced by using the scaling factor. It is understood that teachings provided herein are not limited to the above-described exemplary embodiment.

In addition, where the overall brightness of the backlight block considering the brightness degree of the adjacent blocks is less than the preset threshold brightness, the screen is in a dark state as a whole and the blocking phenomenon is not greatly problematic. Thus, the block control value compensating unit 45 does not perform the compensation process, and it outputs the backlight control value (L_{dim}) for the backlight block, which is calculated by the block control value calculating unit 43, as the backlight compensation control value (L_{sf}) corresponding to the brightness of the backlight block considering the brightness degree of the adjacent blocks.

The backlight controlling unit 50 controls backlight units (not shown) to back-light the LCD panel having the divided display region according to the backlight compensation control value (L_{sf}).

The image signal outputting unit 60 displays the image corresponding to the input image signal on the LCD panel.

Based on the brightness ratio according to the positions of the adjacent blocks of the backlight block, a filtering backlight control value representing the influence on the adjacent blocks is previously registered in the memory. That is, the filter coefficients for the backlight blocks like in FIG. 2B are stored in the memory.

An exemplary method for controlling the brightness in each block will be described below with reference to FIG. 5. In the case where the backlight blocks may have the maximum brightness as illustrated in FIG. 5A, the above-described signal processing unit 40 performs the block-based dimming control and the backlight block may have the brightness of FIG. 5B according to the control signal output from the block control value calculating unit 43. The block control value calculating unit 43 outputs a backlight dimming control signal for each backlight block. FIG. 5B illustrates a brightness graph where the influence of the adjacent blocks is not considered.

However, since each block is practically influenced by the adjacent blocks, some blocks exceed the threshold brightness as illustrated in FIG. 5C and there is a significant different in the actual brightness, causing the blocking phenomenon.

Therefore, in order to check this problem quickly and dynamically during the operation of the display device, the filtering process is performed using the filters of each block to thereby obtain the brightness information like in FIG. 5C.

That is, the block control value compensating unit 45 filters the brightness value of light of the light overlapped region in each backlight block, based on the brightness ratio according to the positions of the adjacent blocks as shown in FIG. 5C.

Then, the filtered brightness value of the light is scaled to be less than the preset threshold brightness as illustrated in FIG. 5D, and the block-based backlight control value is compensated to this brightness. For example, in the case where the backlight control value of a specific block calculated by the block control value calculating unit 43 is 10, where it is determined through the filtering and scaling processes that the influence from the backlight of the adjacent block is 2, the block control value compensating unit 45 corrects the control value of the corresponding block to 8 and outputs the corrected control value.

A display device according to another embodiment may replace the above-described signal processing unit 40 to perform the following function and operation.

That is, the signal processing unit includes an image analyzing unit (not shown) for analyzing the input image signal to extract block-based brightness information of the divided display region, a block control value calculating unit (not shown) for calculating initial brightness information of each backlight block corresponding to the block of the display region through the brightness information, and a block control value compensating unit (not shown) for converting the initial brightness information into a middle brightness information, considering the brightness degree influenced by the brightness degree of the adjacent block in each backlight block, and outputting a backlight control signal corresponding to final brightness information obtained by scaling the middle brightness information at a predetermined ratio.

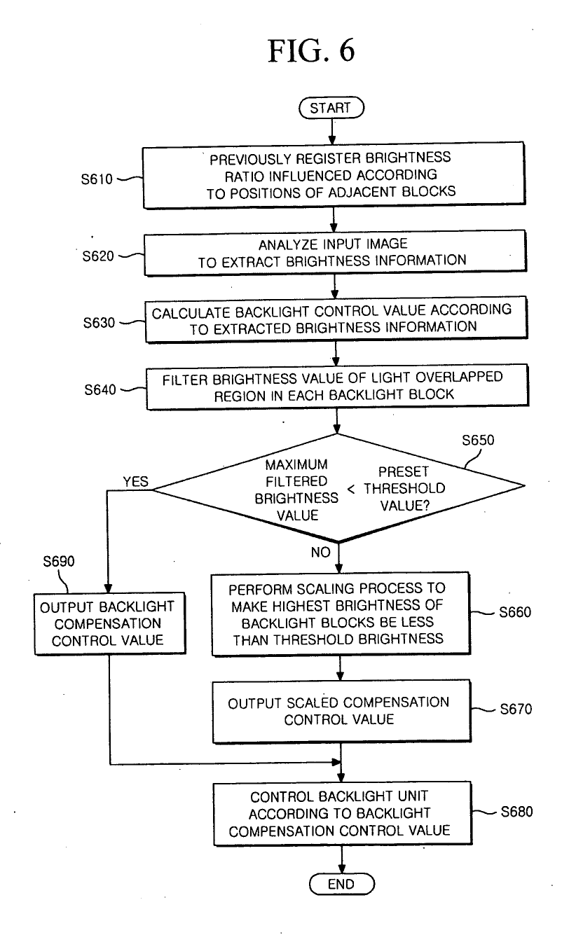

FIG. 6 illustrates a display method according to an exemplary embodiment.

Referring to FIG. 6, in operation S610, the display device 200 previously registers the block-based filter value, that is, the brightness ratio influenced according to the positions of the adjacent blocks in each backlight block.

In operations S620 and S630, the display device 200 analyzes the input image signal to extract brightness information, and calculates a backlight control value according to the extracted brightness information.

In operation S640, the display device 200 filters the brightness value of light of the light overlapped region in each backlight block, based on the brightness ratio influenced by the positions of the adjacent blocks.

That is, the display device 200 may quickly calculate the brightness of the backlight block considering the influence of the brightness of the adjacent blocks by using the previously registered brightness ratio.

In operation S650, the display device 200 determines whether the brightness value filtered in each backlight block is less than the preset threshold value.

In operation S660, where the brightness value is greater than the preset threshold value, the display device 200 scales the highest brightness among the backlight blocks to less than the preset threshold value.

In operation S670, the display device 200 outputs the backlight compensation control value by performing the scaling process of reducing the brightness of other backlight block, based on the converted brightness ratio of the brightest backlight block.

The compensation control value may be easily obtained by storing the block-based brightness and its corresponding control value in a table form in a predetermined storage region, and reading the control value corresponding to the scaled block-based brightness. It is apparent that the compensation control value may be obtained in a similar or different way within the scope of the technical spirit of the instant disclosure.

In operation S680, the display device 200 controls the backlight unit corresponding to the backlight block to back-light the LCD panel by using the acquired backlight compensation control value.

Where it is determined in operation S650 that the brightness value is less than the preset threshold value, the display device 200 outputs the backlight control value calculated in operation S630, without performing the control value compensation, and outputs the backlight compensation control value corresponding to the filtered brightness value in operation S690. In operation S680, using the backlight compensation control value, the display device 200 controls the backlight unit corresponding to the backlight block to back-light the LCD panel.

According to certain embodiment above, it may be possible to compensate for degradation of an image quality in a backlight local dimming control for reducing power consumption.

Furthermore, it may be possible to compensate for a backlight blocking phenomenon occurring in a boundary of a divided backlight blocks in a backlight local dimming control.

The methods described above may be recorded, stored, or fixed in one or more computer-readable media that includes program instructions to be implemented by a computer to cause a processor to execute or perform the program instructions. The media may also include, alone or in combination with the program instructions, data files, data structures, and the like. Examples of computer-readable media include magnetic media, such as hard disks, floppy disks, and magnetic tape; optical media such as CD ROM disks and DVDs; magneto-optical media, such as optical disks; and hardware devices that are specially configured to store and perform program instructions, such as read-only memory (ROM), random access memory (RAM), flash memory, and the like. Examples of program instructions include both machine code, such as produced by a compiler, and files containing higher level code that may be executed by the computer using an interpreter. The described hardware devices may be configured to act as one or more software modules in order to perform the operations and methods described above.

A number of exemplary embodiments have been described above. Nevertheless, it will be understood that various modifications may be made. For example, suitable results may be achieved if the described techniques are performed in a different order and/or if components in a described system, architecture, device, or circuit are combined in a different manner and/or replaced or supplemented by other components or their equivalents. For example, although an image analyzing unit, a block control value calculating unit, and a block control value compensating unit have been described as the elements in an exemplary embodiment, they correspond to a functional modules and thus the above-described modules may be implemented in software or hardware fashion. It is also apparent that the corresponding function may be performed by one module, or it may be further divided and performed by a plurality of modules. Accordingly, other implementations are within the scope of the following claims.

What is claimed is:

1. A signal processing apparatus, comprising:
an image analyzing unit for analyzing an input image signal to extract block-based brightness information of a divided display region;
a block control value calculating unit for calculating a backlight control value for a backlight block corresponding to the block of the display region by using the brightness information; and
a block control value compensating unit for determining whether to perform a scaling process of reducing brightness degree at a predetermined ratio according to brightness of the respective backlight blocks considering brightness degree of adjacent blocks, and outputting a backlight compensation control value.

2. The signal processing apparatus of claim 2, wherein the block control value compensating unit performs the scaling process so that the brightness of the brightest backlight block among the backlight blocks considering the brightness degree of the adjacent blocks is made to be less than a preset threshold brightness, and scales brightness degree of other block, based on the predetermined ratio given by converting the brightest brightness degree, to output the backlight compensation control value corresponding to the scaled brightness.

3. A display device, comprising:
a liquid crystal display panel, divided into a plurality of display regions, for displaying an image according to an input image signal;
a backlight unit, divided into a plurality of backlight blocks corresponding to divided positions of the display region, for back-light the liquid crystal display panel;
a signal processing unit for determining whether to perform a scaling process of reducing brightness degree at a predetermined ratio according to brightness of the respective backlight blocks considering brightness degree influenced by adjacent blocks in the respective backlight blocks by using brightness information of the input image signal, and outputting a backlight compensation control value; and
a backlight controlling unit for controlling the backlight unit of the backlight block according to the backlight compensation control value.

4. The display device of claim 3, wherein the signal processing unit comprises:
an image analyzing unit for analyzing the input image signal to extract block-based brightness information of the divided display region;
a block control value calculating unit for calculating a backlight control value for a backlight block corresponding to the block of the display region by using the brightness information; and
a block control value compensating unit for performing a scaling process so that the brightness of the backlight block considering the brightness degree of the adjacent blocks in the respective backlight blocks is made to be less than a preset threshold brightness, and outputs the backlight compensation control value corresponding to the scaled brightness of the backlight block.

5. The display device of claim 4, wherein the block control value compensating unit performs the scaling process so that the brightness of the brightest backlight block among the backlight blocks considering the brightness degree of the adjacent blocks is made to be less than a preset threshold brightness, and scales brightness degree of other block, based on the predetermined ratio given by converting the brightest brightness degree, to output the backlight compensation control value corresponding to the scaled brightness.

6. The display device of claim 3, further comprising a memory for registering a brightness ratio influenced according to the positions of the adjacent blocks, wherein the block control value compensating unit calculates the brightness of the respective backlight blocks, considering the brightness degree of the adjacent blocks, by using the brightness ratio.

7. The display device of claim 6, wherein the block control value compensating unit filters brightness values of light overlapped regions in the respective backlight blocks, based on the brightness ratio according to the positions of the adjacent blocks, outputs the backlight compensation control value corresponding to the filtered brightness value if the filtered brightness value is less than the threshold value, and performs the scaling process if the filtered brightness value is greater than the threshold value.

8. A display device, comprising:
an image analyzing unit for analyzing the input image signal to extract block-based brightness information of a divided display region;
a block control value calculating unit for calculating initial brightness information of respective backlight blocks corresponding to blocks of the display region by using the brightness information; and
a block control value compensating unit for converting the initial brightness information into middle brightness information, considering brightness degree influenced by brightness degree of adjacent blocks in the respective backlight blocks, and outputting a backlight control signal corresponding to a final brightness information obtained by scaling the middle brightness information at a predetermined ratio.

9. A display method for displaying an image corresponding to an input image signal by back-lighting, the display method comprising:
determining whether to perform a scaling process of reducing brightness degree at a predetermined ratio according to brightness of the respective backlight blocks considering brightness degree according to the input image signal, and generating a backlight compensation control value; and
controlling backlight units corresponding to the backlight block to back-light a liquid crystal display panel according to the backlight compensation control value.

10. The display method of claim 9, further comprising previously registering brightness ratio influenced according to positions of the adjacent blocks.

11. The display method of claim 10, wherein the generating of the backlight compensation control value comprises:
filtering brightness value of a light overlapped region in the respective backlight blocks, based on brightness ratio according to the positions of the adjacent blocks;
determining whether the filtered brightness value is less than a threshold value;
outputting the backlight compensation control value corresponding to the filtered brightness value if the filtered brightness value is less than the threshold value; and
performing the scaling process and outputting the backlight compensation control value corresponding to scaled brightness value if the filtered brightness is greater than the threshold value.

12. The display method of claim 11, wherein the generating of the backlight compensation control value comprises:
performing the scaling process so that the brightness of the brightest backlight block among the respective backlight blocks considering the brightness degree of the adjacent blocks is made to be less than the threshold brightness;
scaling brightness degree of other block, based on the predetermined ratio given by converting the brightest brightness degree; and
outputting the backlight compensation control value corresponding to the scaled brightness.
